(19) United States
(12) Patent Application Publication
(10) Pub. No.: US 2025/0224221 A1
(43) Pub. Date: Jul. 10, 2025

(54) Tape Measure with Built-In Angle/Pitch Finder

(71) Applicant: Ricky Tharp, Gilbertsville, KY (US)

(72) Inventor: Ricky Tharp, Gilbertsville, KY (US)

(21) Appl. No.: 18/950,671

(22) Filed: Nov. 18, 2024

Related U.S. Application Data
(60) Provisional application No. 63/617,949, filed on Jan. 5, 2024.

(51) Int. Cl. G01B 3/1092; G01B 3/1005; G01B 3/1007; G01B 3/1048; G01B 3/1084; G01B 3/56

(52) U.S. Cl. CPC G01B 3/1092; G01B 3/1005; G01B 3/1007; G01B 3/1048; G01B 3/56; G01B 2003/103; G01B 2003/1033; G01B 2003/1087

(57) ABSTRACT

A tape measure with built-in angle/pitch finder device that combines a tape measure and an angle/pitch finder into one tool is disclosed. The tape measure with built-in angle/pitch finder device is a 15 to 50 foot, for example, tape measure with the addition of angle/pitch finder markings on the outside face of the case, protected via a clear plastic lens. The tape measure can also be made with a light inside of it to read the markings in low light conditions. Digital models can be available with a readout display on the exterior of the housing. Thus, users can apply the device to measure degree or pitch of a roof, measure dimensions, and other applications with a single tool.

### CROSS-REFERENCE TO RELATED APPLICATION

The present application claims priority to, and the benefit of, U.S. Provisional Application No. 63/617,949, which was filed on Jan. 5, 2024, and is incorporated herein by reference in its entirety.

### FIELD OF THE INVENTION

The present invention relates generally to the field of tape measure devices. More specifically, the present invention relates to a tape measure with a built-in angle/pitch finder. Accordingly, this disclosure makes specific reference thereto the present invention. Nonetheless, it is to be appreciated that aspects of the present invention are also equally applicable to other such as applications, devices and methods of manufacture.

### BACKGROUND

By way of background, this invention relates to improvements in tape measure devices. Generally, tape measures and angle/pitch finders are independent tools that are often used together. Individuals must carry around a tape measure and an angle/pitch finder to utilize both tools, taking up valuable storage space. Constantly swapping between tools can be frustrating, and angle/pitch finders are often large and bulky.

Accordingly, there is a demand for an improved tape measure with built-in angle/pitch finder device that saves storage space and hassle while completing projects. More particularly, there is a demand for a tape measure with built-in angle/pitch finder device that combines a tape measure and angle/pitch finder in one convenient tool.

Therefore, there exists a long felt need in the art for a tape measure with built-in angle/pitch finder device that provides users with a combination tape measure and angle/pitch finder designed to offer convenience and save space by combining two tools into one. There is also a long felt need in the art for a tape measure with built-in angle/pitch finder device that features a 15 to 50-foot tape measure with angle markings placed on the outside face of the case. Further, there is a long felt need in the art for a tape measure with built-in angle/pitch finder device that includes a built-in light to be used at night, early morning hours, or other lowlight conditions. Moreover, there is a long felt need in the art for a device that offers different models such as a digital version for further convenience. Finally, there is a long felt need in the art for a tape measure with built-in angle/pitch finder device that enables users to simultaneously measure dimensions and identify the degree or pitch of a roof, among numerous other applications.

The subject matter disclosed and claimed herein, in one embodiment thereof, comprises a tape measure with built-in angle/pitch finder device. The device is a novel tape measure with a built-in angle/pitch finder that combines a tape measure and angle/pitch finder into one tool. The tape measure with built-in angle/pitch finder device is a 15 to 50 foot, for example, tape measure with the addition of angle/pitch finder markings on the outside face of the case, protected via a clear plastic lens. The tape measure may also be made with a light inside of it to read the markings in low light conditions. Digital models can be available with a readout display on the exterior of the housing. Thus, users can apply the device and measure degree or pitch of a roof, length measurements, and other applications with a single tool. Accordingly, the device saves space and hassle during projects that require both tools.

In this manner, the tape measure with built-in angle/pitch finder device of the present invention accomplishes all of the forgoing objectives and provides users with a device that enables for a single tool that operates as a tape measure and/or angle/pitch finder.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tape measure with built-in angle/pitch finder device. The device is a combination tool that features a tape measure and angle/pitch finder. The device is designed to offer convenience and to save space by combining two tools into one. The tape measure with built-in angle/pitch finder device comprises a tape measure component and an angle/pitch finder component. Thus, users can apply the device and measure degree or pitch of a roof, dimension measurements, and other applications with a single tool.

In one embodiment, the tape measure with built-in angle/pitch finder device of the present invention assists any setting in which a tape measure and/or angle/pitch finder is required. The tape measure with built-in angle/pitch finder device combines a tape measure and angle/pitch finder into one convenient tool. The tape measure with built-in angle/pitch finder device features a 15 to 50 foot tape measure with angle markings placed on the outside face of the case. The tape measure with built-in angle/pitch finder device includes a built-in light to be used at night, early morning hours, or other low light conditions. The device offers different models such as a digital version for further convenience. The device enables users to simultaneously measure dimensions and identify the degree or pitch of a roof, among numerous other applications. The device is portable in that it is configured to be easily carried by a person.

In one embodiment, the tape measure with built-in angle/pitch finder device comprises a tape measure component. The tape measure component is configured in a traditional tape measure shape but can be configured in any suitable shape as is known in the art. The tape measure component comprises a case, a spring-loaded retraction mechanism, a thumb lock, a blade, and a hook.

In one embodiment, the tape measure component of the tape measure with built-in angle/pitch finder device functions as a traditional tape measure. The case of the tape measure component houses the spring-loaded retraction mechanism and blade within and features a thumb lock externally. The blade features a hook on the end, and the thumb lock is used to lock the tape measure in an extended or retracted position.

In one embodiment, the tape measure with built-in angle/pitch finder device comprises an angle/pitch finder component. The angle/pitch finder component is configured in a circular shape but can be configured in any suitable shape as is known in the art. The angle/pitch finder component comprises a clear lens, a dial, angle indicium, a needle, a weight, and a light.

In one embodiment, the angle/pitch finder component of the tape measure with built-in angle/pitch finder device is mechanical, although digital versions can be made available for further convenience.

In one embodiment, a clear lens houses the angle/pitch finder component. Through this lens, a dial, needle, and a weight are seen. A light is positioned behind the dial for working in low light conditions. The dial features angle indicium. Users read or delineate angle measurements using the needle, which features a weight at the opposite end.

In one embodiment, the tape measure with built-in angle/pitch finder device in accordance with the present invention can be produced in various colors, designs, patterns, etc., and feature logos, emblems and or designs, such as a distributor requests and/or a user desires.

In one embodiment, the tape measure with built-in angle/pitch finder device is manufactured of a high-density polyethylene (HDPE), or any other suitable materials as is known in the art. Any number of different types of materials can be used to make the tape measure with built-in angle/pitch finder device including but not limited to plastics, nylon, metals, etc.

In use, the user can measure the length of objects using the tape measure component. The user can also measure the angle of a surface of an object using the angle/pitch finder component. The user can then utilize the device while completing projects, which enables for two tools to be combined into one. Thus, the tape measure with built-in angle/pitch finder device saves space and hassle while completing projects compared to ordinary methods. By providing a combination tool, the device offers convenience to users. Further, the device includes a built-in light for low light conditions and can be available in digital versions for even further convenience.

It will also be appreciated that there are a number of additional add-on features that can be incorporated into the device and moreover, the tape measure with built-in angle/pitch finder device can take many different forms as is known in the art.

In yet another embodiment, the tape measure with built-in angle/pitch finder device comprises a plurality of indicium.

In yet another embodiment, a method of conveniently measuring lengths and angles utilizing the tape measure with built-in angle/pitch finder device is disclosed. The method includes the steps of providing a tape measure with built-in angle/pitch finder device comprising a tape measure component and an angle/pitch finder component. The method also comprises measuring the length of an object using the tape measure component. Further, the method comprises measuring the angle of an object's surface using the angle/pitch finder component. Finally, the method comprises utilizing the device while completing projects.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an enlarged perspective view of one embodiment of the tape measure with built-in angle/pitch finder device of the present invention showing the tape measure component and integrated angle/pitch finder component in accordance with the disclosed architecture;

FIG. 2 illustrates another enlarged perspective view of one embodiment of the tape measure with built-in angle/pitch finder device of the present invention showing the tape measure component and integrated angle/pitch finder component in accordance with the disclosed architecture;

FIG. 3 illustrates a perspective view of a sketch of one embodiment of the tape measure with built-in angle/pitch finder device of the present invention in accordance with the disclosed architecture;

FIG. 4 illustrates another enlarged perspective view of one embodiment of the tape measure with built-in angle/pitch finder device of the present invention showing the tape measure component and integrated angle/pitch finder component in accordance with the disclosed architecture;

FIG. 5 illustrates another enlarged perspective view of one embodiment of the tape measure with built-in angle/pitch finder device of the present invention showing the tape measure component and integrated angle/pitch finder component in accordance with the disclosed architecture; and

FIG. 6 illustrates a flowchart outlining a novel method of conveniently measuring lengths and angles utilizing the tape measure with built-in angle/pitch finder device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a tape measure with built-in angle/pitch finder device that provides users with a combination tape measure and angle/pitch finder designed to offer convenience and save space by combining two tools into one. There is also a long felt need in the art for a tape measure with built-in angle/pitch finder device that features a 15 to 50-foot, for example, tape measure with angle markings placed on the outside face of the case. Further, there is a long felt need in the art for a tape measure with built-in angle/pitch finder device that includes a built-in light to be used at night, early morning hours, or other lowlight conditions. Moreover, there is a long felt need in the art for a device that offers different models such as a digital version for further convenience. Finally, there is a long felt need in the art for a tape measure with built-in angle/pitch finder device that enables users to simultaneously measure dimensions and identify the degree or pitch of a roof, among numerous other applications.

The present invention, in one exemplary embodiment, is a novel tape measure with built-in angle/pitch finder device that combines a tape measure and angle/pitch finder into one tool. The tape measure with built-in angle/pitch finder device is a 15 to 50 foot tape measure with the addition of angle/pitch finder markings on the outside face of the case, protected via a clear plastic lens. The tape measure may also be made with a light inside of it to read the markings in low light conditions. Digital models can be available with a readout display on the exterior of the housing. Thus, users can apply the device and measure degree or pitch of a roof and other applications with a single tool. The present invention also includes a novel method of conveniently measuring lengths and angles utilizing the tape measure with built-in angle/pitch finder device. The method includes the steps of providing a tape measure with built-in angle/pitch finder device comprising a tape measure component and angle/pitch finder component. The method also comprises measuring the length of an object using the tape measure component. Further, the method comprises measuring the angle of an object's surface using the angle/pitch finder component. Finally, the method comprises utilizing the device while completing projects.

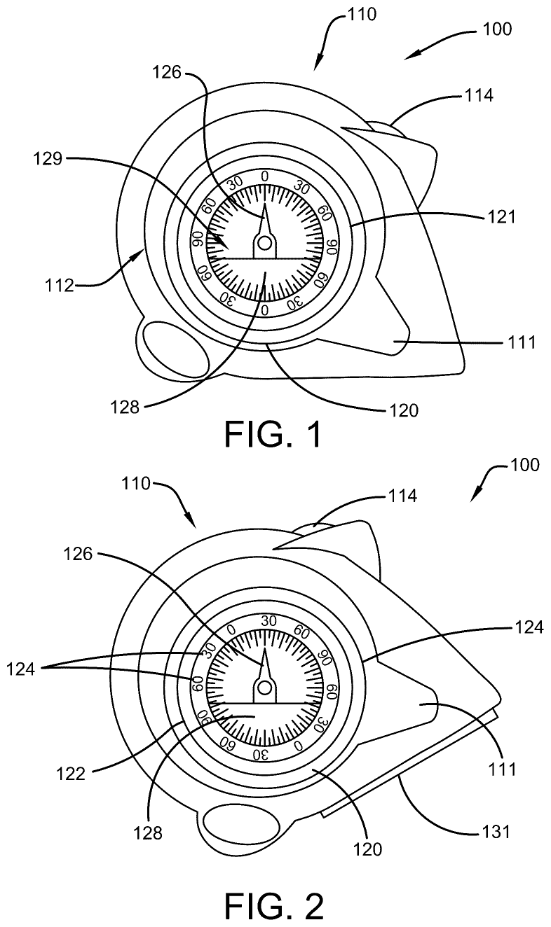

Referring initially to the drawings, FIGS. 1 and 2 illustrate enlarged perspective views of one embodiment of the tape measure with built-in angle/pitch finder device 100 of the present invention showing the tape measure component 110 and integrated angle/pitch finder component 120. The device 100 is a combination tool that features a tape measure 110 and angle/pitch finder 120. The device 100 is designed to offer convenience and to save space by combining two tools into one. The tape measure with built-in angle/pitch finder device 100 comprises a tape measure component 110 and an angle/pitch finder component 120. Thus, users can apply the device 100 and measure the degree or pitch of a roof, measure dimensions, and other applications with a single tool. In one embodiment, the case or housing 111 includes a magnetic base 131 for affixing a position of the device 100 to a magnetic surface.

In the present embodiment, the tape measure with built-in angle/pitch finder device 100 assists any setting in which a tape measure and/or angle/pitch finder is required. The tape measure with built-in angle/pitch finder device 100 combines a tape measure 110 and angle/pitch finder 120 into one convenient tool. The tape measure with built-in angle/pitch finder device features a 15 to 50 foot tape measure with angle markings placed on the outside face of the case. The tape measure with built-in angle/pitch finder device 100 includes a built-in light to be used at night, early morning hours, or other low light conditions. The device 100 offers different models such as a digital version for further convenience. The device 100 enables users to simultaneously measure dimensions and identify the degree or pitch of a roof, among numerous other applications. The device 100 is portable in that it is configured to be easily carried by a person.

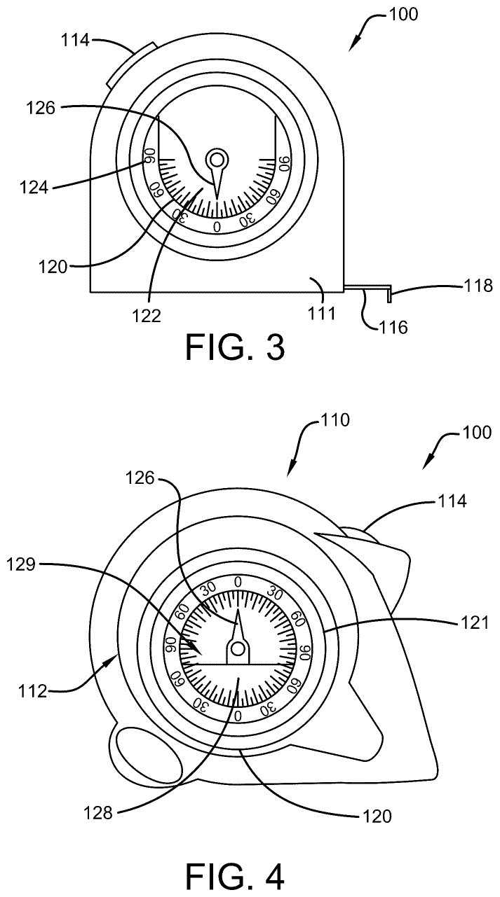

As shown in FIG. 3, the tape measure with built-in angle/pitch finder device 100 comprises a thumb lock 114, blade 116, and a hook 118 as part of the tape measure component 110. The thumb lock 114, blade 116, and hook 118 are typically configured in the fashion of a standard tape measure.

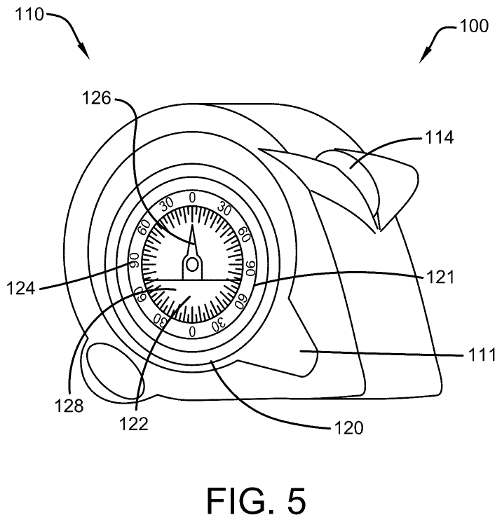

Shown in FIGS. 4 and 5 are enlarged perspective views of one embodiment of the tape measure with built-in angle/pitch finder device 100 of the present invention showing the tape measure component 110 and integrated angle/pitch finder component 120. In the present embodiment, the tape measure with built-in angle/pitch finder device 100 comprises a tape measure component 110. The tape measure component 110 is configured in a traditional tape measure shape but can be configured in any suitable shape as is known in the art. The tape measure component 110 comprises a case or housing 111, a spring-loaded retraction mechanism 112, a thumb lock 114, a blade 116, and a hook 118.

In the present embodiment, the tape measure component 110 of the tape measure with built-in angle/pitch finder device 100 functions as a traditional tape measure. The case or housing 111 of the tape measure component 110 houses the spring-loaded retraction mechanism 112 and blade 116 within and features a thumb lock 114 externally. The blade 116 features a hook 118 on the end, and the thumb lock 114 is used to lock the tape measure 110 in an extended or retracted position.

In the present embodiment, the tape measure with built-in angle/pitch finder device 100 comprises an angle/pitch finder component 120. The angle/pitch finder component 120 is configured in a circular shape but can be configured in any suitable shape as is known in the art. The angle/pitch finder component 120 comprises a clear lens 121, a dial 122, angle indicium 124, a needle 126, a pivotal weight 128, and a light 129.

In the present embodiment, the angle/pitch finder component 120 of the tape measure with built-in angle/pitch finder device 100 is mechanical, although digital versions can be made available for further convenience.

In the present embodiment, a clear lens 121 houses the angle/pitch finder component 120. Through this lens 121, a dial 122, needle 126, and a pivotal weight 128 are seen. The pivotal weight 128 self-levels as the tape measure and pitch finder device 100 is placed at an angle. The self-leveling of the weight 129 moves the connected needle 126 to delineate the angle of the pitch. A light 129 is positioned behind the dial 122 for working in low light conditions. The dial 122 features angle indicium 124. Users read or delineate angle measurements using the needle 126, which features a pivotal weight 128 integrated at an opposing end.

It is to be appreciated that the tape measure with built-in angle/pitch finder device 100 in accordance with the present invention can be produced in various colors, designs, patterns, etc., and feature logos, emblems and or designs, such as a distributor requests and/or a user desires.

In one embodiment, the tape measure with built-in angle/pitch finder device 100 is manufactured of a high-density polyethylene (HDPE), or any other suitable materials as is known in the art. Any number of different types of materials can be used to make the tape measure with built-in angle/pitch finder device 100 including but not limited to nylon, metals, heat-scalable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc. Generally, the tape measure with built-in angle/pitch finder device 100 is also manufactured from a material that is water resistant or waterproof, or the case or housing 111 comprises a coating that is water resistant or waterproof.

In yet another embodiment, the tape measure with built-in angle/pitch finder device 100 comprises a plurality of indicium 400. The case or housing 111 of the device 100 may include advertising, a trademark, or other letters, designs, or characters, printed, painted, stamped, or integrated into the case or housing 111, or any other indicium 400 as is known in the art. Specifically, any suitable indicium 400 as is known in the art can be included, such as but not limited to, patterns, logos, emblems, images, symbols, designs, letters, words, characters, animals, advertisements, brands, etc.

It will also be appreciated that there are a number of additional add-on features that can be incorporated into the device 100 and moreover, the tape measure with built-in angle/pitch finder device 100 can take many different forms as is known in the art.

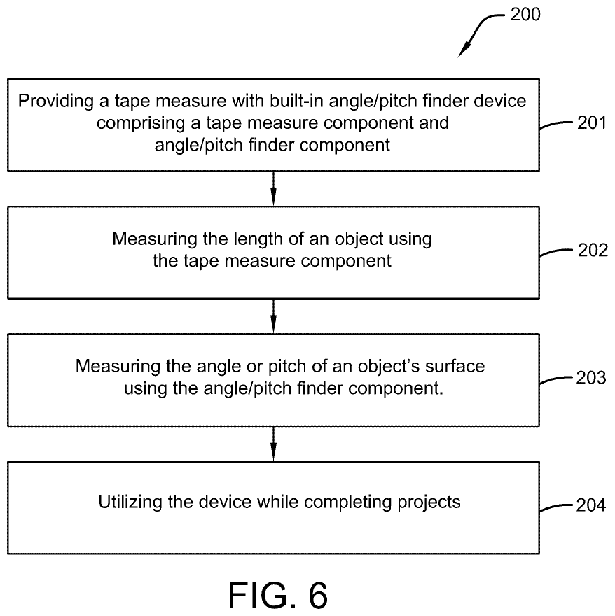

FIG. 6 illustrates a flowchart of the method 200 of conveniently measuring lengths and angles utilizing the tape measure with built-in angle/pitch finder device. The method includes the steps of at 201, providing a tape measure with built-in angle/pitch finder device comprising a tape measure component 110 and angle/pitch finder component 120. The method also comprises 202, measuring the length of an object using the tape measure component. Further, the method comprises 203, measuring the angle or pitch of an object's surface using the angle/pitch finder component. Finally, the method comprises 204, utilizing the device while completing projects.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “tape measure with built-in angle/pitch finder device”, “tape measure device”, “angle/pitch finder device”, and “device” are interchangeable and refer to the tape measure with built-in angle/pitch finder device 100 of the present invention.

Notwithstanding the forgoing, the tape measure with built-in angle/pitch finder device 100 of the present invention can be of any suitable size and configuration as is known in the art without affecting the overall concept of the invention, provided that it accomplishes the above stated objectives. One of ordinary skill in the art will appreciate that the tape measure with built-in angle/pitch finder device 100 as shown in FIGS. 1-5 is for illustrative purposes only, and that many other sizes and shapes of the tape measure with built-in angle/pitch finder device 100 are well within the scope of the present disclosure. Although the dimensions of the tape measure with built-in angle/pitch finder device 100 are important design parameters for user convenience, the tape measure with built-in angle/pitch finder device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tape measure with built-in pitch finder comprising:
a case;
a tape measure; and
a pitch finder;
wherein said case containing said tape measure and said pitch finder;
wherein said tape measure measures dimensions;
wherein said pitch finder measures pitch angles;
wherein said pitch finder housed on an outer side of said case; and
further wherein the dimensions and the pitch angles are measurable simultaneously.

2. The tape measure with built-in pitch finder of claim 1, wherein said case having a magnetic base.

3. The tape measure with built-in pitch finder of claim 1, wherein said pitch finder having a light for illuminating said pitch finder during low light.

4. The tape measure with built-in pitch finder of claim 3, wherein said case having a spring-loaded retraction mechanism for retracting said tape measure.

5. The tape measure with built-in pitch finder of claim 4, wherein said case having a thumb lock for locking said tape measure selectively in a retracted position and an extended position.

6. The tape measure with built-in pitch finder of claim 1, wherein said pitch finder having a circular shape.

7. The tape measure with built-in pitch finder of claim 3, wherein said pitch finder having a clear lens, a dial, an angle indicium, a pivotal weight, and a needle for delineating the pitch angles.

8. A tape measure with built-in pitch finder comprising:
a case;
a tape measure; and
a pitch finder;
wherein said case containing said tape measure and said pitch finder;
wherein said tape measure measures dimensions;
wherein said pitch finder measures pitch angles;
wherein said pitch finder housed on an outer side of said case;
wherein the dimensions and the pitch angles are measurable simultaneously; and
further wherein said pitch finder having a clear lens, a dial, an angle indicium, a pivotal weight, and a needle for delineating the pitch angles.

9. The tape measure with built-in pitch finder of claim 8, wherein said case having a magnetic base.

10. The tape measure with built-in pitch finder of claim 8, wherein said pitch finder having a light for illuminating said pitch finder during low light.

11. The tape measure with built-in pitch finder of claim 8, wherein said case having a spring-loaded retraction mechanism for retracting said tape measure.

12. The tape measure with built-in pitch finder of claim 8, wherein said case having a thumb lock for locking said tape measure selectively in a retracted position and an extended position.

13. The tape measure with built-in pitch finder of claim 8, wherein said pitch finder having a circular shape.

14. A tape measure with built-in pitch finder comprising:
a case;
a tape measure; and
a pitch finder;
wherein said case containing said tape measure and said pitch finder;
wherein said tape measure measures dimensions;
wherein said pitch finder measures pitch angles;
wherein said pitch finder housed on an outer side of said case;
wherein the dimensions and the pitch angles are measurable simultaneously; and
further wherein said pitch finder having a self-leveling weight at one end and a needle at an opposing end.

15. The tape measure with built-in pitch finder of claim 14, wherein said self-leveling weight self-levels for moving said needle along an angle indicium for delineating the pitch angles of said pitch finder.

16. The tape measure with built-in pitch finder of claim 15, wherein said tape measure having a length from 15 feet to 50 feet.

17. The tape measure with built-in pitch finder of claim 15, wherein said pitch finder having a light for illuminating said pitch finder during low light.

18. The tape measure with built-in pitch finder of claim 16, wherein said case having a spring-loaded retraction mechanism for retracting said tape measure.

19. The tape measure with built-in pitch finder of claim 18, wherein said case having a thumb lock for locking said tape measure selectively in a retracted position and an extended position.

20. The tape measure with built-in pitch finder of claim 19, wherein said pitch finder having a circular shape.
